(19) United States
(12) Patent Application Publication
(10) Pub. No.: US 2006/0059551 A1
(43) Pub. Date: Mar. 16, 2006

(54) Dynamic firewall capabilities for wireless access gateways

(75) Inventor: Michael Borella, Rolling Meadows, IL (US)

Correspondence Address: William L. Botjer, P.O. Box 478, Center Moriches, NY, 11934, US

(73) Assignee: UTSTARCOM INC.

(21) Appl. No.: 10/939,675

(22) Filed: Sep. 13, 2004

(51) Int. Cl. G06F 15/16

(52) U.S. Cl. 726/13

(57) ABSTRACT

The present invention provides a method and system for dynamic filtering of data packets at an access gateway in a communication network. According to the method, a policy server receives a request for registration with the network from a network node. The server verifies the network node identity and selects the corresponding security policy for the network node. The selected security policy is indicated by the server to a network access gateway. The network access gateway selects the indicted security policy. The selected security policy is applied for the communication between the network node and the network.

### BACKGROUND

The present invention relates to dynamic filtering capabilities for providing network security at wireless and wire line access gateways. In particular, the present invention relates to dynamic firewalls on Packet Data Serving Nodes (PDSNs) and home agents (HAs) in a CDMA2000 wireless network.

Information exchange over the Internet poses a security risk to networks involved in the information exchange, as this involves allowing outsiders to access the networks. Illegitimate users can change data, gain unauthorized access to data, destroy data, or make unauthorized use of the network resources.

These security issues require implementation of safeguards that ensure security of such networks and associated resources. The most commonly used technique of controlling undesirable or illegitimate access to the networks involves the firewall technology. A firewall is a set of related programs implemented on a specific hardware. In a network, the hardware is usually a network gateway server. The network gateway server is a point that acts as an entrance to another network. The gateway is often associated with a router or a switch. The router knows the destination of the data packets that arrive at the gateway. The firewall works closely with a router program to provide rules-based profiles that allow or deny network packets to and from the network. For an Open System Interconnection (OSI) network model, normally the rules-based profiles deny or allow communication sessions based on layer two through layer seven information in packets. For example, a particular firewall rule may look like:
If (interface==eth0&&ip.src==149.112.164.0/24&&tcp.dst==22)
allow;
Else deny;

The above rule allows packets from Ethernet interface 0 with a source IP address range of 149.112.164.0-149.112.164.255 to use the service at port 22, but deny all other transactions. Additionally, the firewall rules may be fixed or dynamic. In the example given above, the rule is a fixed one.

Dynamic firewalls, also called stateful firewalls, monitor the communication status between two networks. The information regarding the communication status is stored in a table called a state table. Various types of information that varies with the protocol used by the communicating hosts can be stored in the state table. For example, a state table may include information on the source and destination IP address, source and destination port, protocol, flag, sequence, acknowledgement numbers, application type, application data, etc. Based upon a particular state, and the corresponding security policy set for that state, the firewall decides whether a packet should be allowed or denied.

For instance, a firewall may block all Transmission Control Protocol (TCP) ports of a host, which is being protected by the firewall. Each time the protected host establishes a TCP session to a server on the Internet, a dynamic firewall will remember that the session is up. Thus, as long as the session is alive, the dynamic firewall will allow TCP packets from the server with the appropriate port numbers to pass through. In another instance, when a private network client makes an outbound connection to a server, the firewall might store the source and destination IP addresses and port numbers in the state table. The firewall can also enter other types of information in the state table. When the firewall receives the server's response, it checks the state table to see if any outbound requests to that server have been made. If a corresponding entry exists in the state table, then the firewall passes the response to the internal network client who made the outbound request.

Firewalls, and more particularly dynamic firewalls, implemented at access gateways of a network are important. This is because, with the help of firewalls access gateways are able to prevent a network user's traffic from being routed to another user or anywhere except to and from the target user. Moreover, firewalls have the capability to prevent certain types of network probes and attacks. Without firewalls or a similar functionality, the network element is open to attacks from malicious hosts on the Internet. These include attacks that are meant to spread computer viruses, Trojan horses, and other types of exploitations. Also, unlimited Internet connectivity opens a network element to denial-of-service (DoS) attacks that utilizes the computing resources of the network and network elements to do useless computations, thus preventing the end user from executing the desired applications.

A wireless network is particularly vulnerable to port scans and IP address range scans. These attacks cause unnecessary utilization of expensive radio network resources. Firewalls allow a network service provider to control the applications and services to which individual users have an access, thereby, preventing such attacks. Additionally, some users may be allowed access to particular application servers while others might be blocked, by a firewall, from accessing these services.

In CDMA2000 wireless networks, firewalls can be implemented at access nodes such as the Packet Data Serving Node (PDSN) and the Home Agent (HA). The firewalls perform the filtering operation on the data packets communicated through these access gateways. Filtering refers to the use of firewalls to screen data packets communicated over a network, thereby, allowing or denying the data packets to enter or leave the network.

The CDMA2000 PDSN provides access to the Internet, intranets, and application servers for mobile stations. Broadly stated, PDSNs provide mobile stations with a gateway to the IP network. The CDMA2000 HA is a router on the home network of a mobile node. The HA maintains information about the current location of the mobile node. The HA uses a tunneling mechanism to direct data to and from the mobile node over the Internet in such a manner that the IP address of the mobile node is not required to be changed each time it connects from a different location. In tunneling, the transmission of data intended for a private network is made through a public network in such a manner that the routers in the public network are unaware that the transmission is a part of a private network.

However, there is no provision for performing the filtering operation selectively. Therefore, there is a need for a method and a system for filtering data packets in a manner that the filtering for a specific type of a data packet is performed at only one location in a network.

### SUMMARY

An object of the present invention is to provide a user-based filtering mechanism for dynamic filtering of data packets in a communication network wherein a specific filter is applied on only one component in the communication network.

Another object of the present invention is to provide a filtering mechanism for filtering data packets associated with a network node at an access gateway if the network node is communicating through mobile internet protocol with reverse tunneling, the access gateway is a home agent of a home network corresponding to the network node.

Another object of the present invention is to provide a filtering mechanism for filtering data packets associated with a network node at an access gateway, in cases where the network node is communicating through simple internet protocol or through mobile internet protocol without reverse tunneling, and the access gateway is a packet data serving node of a network other that the home network corresponding to the network node.

Another object of the present invention is to provide a filtering mechanism for dynamic filtering of data packets at an access gateway, in cases where the server that indicates the appropriate security policy for the network node is either one or both of: a local policy server configured for the purpose, or an authentication, authorization, and accounting server configured to indicate the appropriate security policy.

To achieve these objectives, the present invention provides a system and method for dynamic filtering of data packets in a network. The method comprises receiving a registration request from a network node for access to a network, answering the registration request, and filtering data packets associated with the network node at an access gateway. The registration request comprises an identifier that indicates, among other parameters, the location of the network node, and the access gateway is selected on the basis of the location of the network node, as indicated by the identifier.

### BRIEF DESCRIPTION OF THE DRAWINGS

The various embodiments of the invention will hereinafter be described in conjunction with the appended drawings provided to illustrate and not to limit the invention, wherein like designations denote like elements, and in which:

FIG. 1 illustrates an exemplary internetworking environment in which an embodiment in accordance with the system of the present invention has been implemented; and

FIG. 2 is a flow chart of the filtering process in accordance with an embodiment of the present invention.

### DETAILED DESCRIPTION OF THE INVENTION

The present invention offers a dynamic filtering mechanism to network service providers and users for use on a network access gateway. The filtering mechanism of the present invention is an advancement over the traditional dynamic firewalls.

Several types of wireless or wire line access gateways can be supported by this invention, such as Code Division Multiple Access (CDMA) gateways, General Packet Radio Service/Universal Mobile Telecommunications System (GPRS/UMTS) gateways, Gateway GPRS Support Nodes (GGSNs), and 802.11 roaming gateways.

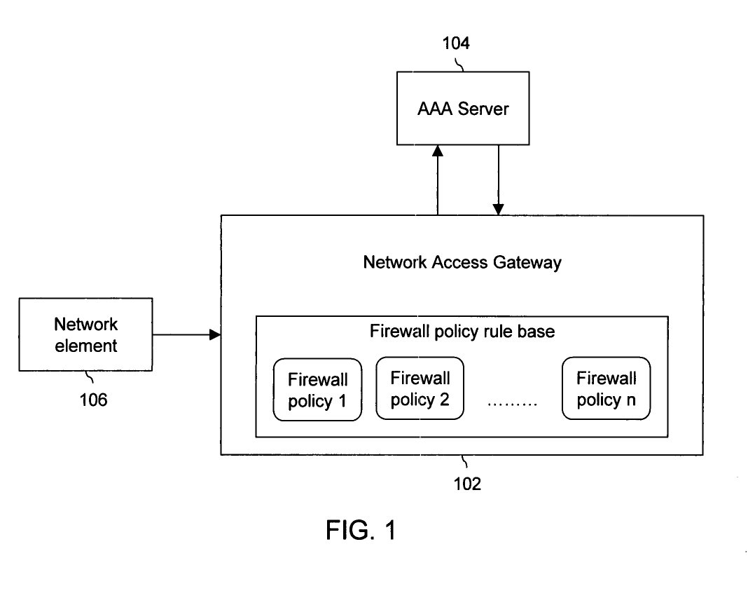

FIG. 1 illustrates an internetworking environment where an embodiment in accordance with the system of the present invention has been implemented. The dynamic firewall of the system of the present invention is embedded on a Network Access Gateway 102. According to an embodiment of the present invention, a Packet Data Serving Node (PDSN) or a Home Agent (HA) acts as an access gateway between CDMA2000 Radio Access Network (RAN) and Internet Protocol (IP) based networks. However, the system of the present invention is not limited to PDSN or HA and is applicable to any other type of access gateway for a network. The standard by which devices or applications communicate with an Authentication, Authorization, and Accounting (AAA) Server 104 is the Remote Authentication Dial-In User Service (RADIUS). However, the use of RADIUS as a communication standard should not be considered limiting to the scope and spirit of the present invention. Other standards such as Diameter, or any other suitable standard can also be used.

Network Access Gateway 102 communicates with AAA Server 104 for exchanging security information corresponding to a network user. The network user could be a Network Element 106. Network Element 106 can be any network device for communication. For example, Network Element 106 can be a desktop computer, a mobile phone, a laptop, a Personal Digital Assistant (PDA), and so on. Network Element 106 registers with the CDMA2000 network by sending a signal to Network Access Gateway 102.

Network Access Gateway 102 in turn communicates the information about the registration of Network Element 106 to AAA Server 104. A server program embedded in AAA Server 104 manages the information sent by Network Access Gateway 102 regarding Network Element 106 registration and access requests. AAA Server 104 provides authentication, authorization and accounting services for all the network elements registered with the CDMA2000 network of the present invention.

Referring to FIG. 1, Network Access Gateway 102 of the present invention is provisioned with various sets of firewall policies. These sets of firewall policies may also be called a rulebase. The firewall rulebase is a technical implementation of the security policy of a network. Individuals with appropriate authority may decide the security policy. The security policy may consist of rules such as: allow incoming data packets from Ethernet Interface ‘0’ with a specific source IP address range only, deny access to selected sites, or any other rule. The firewall of the present invention determines the technical requirements and implements these rules. The technical requirements and implementation is specified in the form of a computer program that is embedded in Network Access Gateway 102.

When Network Element 106 registers with the CDMA2000 network, a request is sent to Network Access Gateway 102. Network Access Gateway 102 can be a PDSN and/or a HA. In an embodiment of the invention, AAA Server 104 applies some rules to the PDSN and others to the HA, when appropriate, so that the same rule is not applied twice to the same packet as the packet traverses these elements.

In another embodiment, Network Access Gateway 102 is a PDSN if Network Element 106 is located in a network other than its home network. A home network is the network in which a mobile device has its permanent IP address. A network other than the home network can be referred to as a foreign network. A mobile device, in this case Network Element 106, gets a temporary care-of address each time it visits a foreign network. The care-of address allows the determination of the location of Network Element 106 when it is not present in its home network. The PDSN can provide simple IP and mobile IP access, foreign agent support, and packet transport for virtual private networking. However, if Network Element 106 is present in its home network, Network Access Gateway 102 is the HA. The HA, as known in the art, is a router on the home network of Network Element 106. The HA maintains information about the location of Network Element 106 as identified in its care-of address, and uses tunneling mechanisms to forward network traffic to Network Element 106 when Network Element 106 is in a foreign network.

On receiving the registration request from Network Element 106, Network Access Gateway 102 informs AAA Server 104 that a request for accessing the network has been received. The content of the registration request includes an identifier for identifying Network Element 106. Further, the identifier comprises, among other information, details on the location of Network Element 106. The location of Network Element 106 indicates whether Network Element 106 is in the home network or in a foreign network.

After receiving the request for access from Network Access Gateway 102, AAA Server 104 responds with an access-reply for Network Element 106. AAA Server 104 provides a framework for intelligent control of access to computer resources, enforcement of appropriate security policies, auditing usage of network resources, and for recording information necessary for billing of services utilized by a Network user. Since AAA Server 104 provides for the enforcement of appropriate security policy, access-reply from AAA Server 104 may include, among other parameters, an indication of the firewall policy to be applied. The format of the indicator coming from AAA Server 104 can be an attribute of AAA Server 104. For example, it may be a ‘filter-name’ attribute that specifies the name of one of the filters configured on Network Element 106. In an embodiment of the invention, the format can include an ASCII string with the name of the filter. AAA Server 104 only indicates the appropriate firewall policy for Network Element 106, and does not actually provide the firewall policy. This is because the firewall rulebase that consists of several firewall policies is embedded in Network Access Gateway 102 and not in AAA Server 104. AAA Server 104 responds with parameters that are defined in accordance with Network Element 106. AAA Server 104 identifies parameters corresponding to Network Element 106 from its identity attribute that was passed on at the time of registration of Network Element 106.

In accordance with an embodiment of the present invention, AAA Server 104 scans the information provided by the identifier for Network Element 106. Particularly, information regarding the location of Network Element 106 aids AAA Server 104 to determine the type of Network Access Gateway 102 whose firewall will be applicable for Network Element 106. In an embodiment of the present invention, if Network Element 106 is present in a foreign network, and is receiving information packets from its home network through tunneling, AAA Server 104 directs the filtering of data packets to be performed at the PDSN. In other words, AAA Server points to one of the firewall policies at the PDSN that corresponds to Network Element 106. Additionally, if Network Element 106 is present in any network and requests for access to the network through simple IP, AAA Server 104 directs the filtering of data packets to be performed at the PDSN of the network where Network Element 106 is currently located. However, if Network Element 106 is located in a foreign network and communicates with its home network by sending data packets to a correspondent node in the home network, AAA Server 104 directs the filtering to be performed at the HA in the home network. In the latter case, the communication is carried out through reverse tunneling.

Therefore, Network Access Gateway 102 receives several attributes including the corresponding firewall policy for Network Element 106 from access-reply sent by AAA Server 104. Network Access Gateway 102 then enables access to network resource for Network Element 106 as defined by the parameters. Moreover, Network Access Gateway 102 applies the firewall policy as indicated by AAA Server 104 to the traffic of Network Element 106.

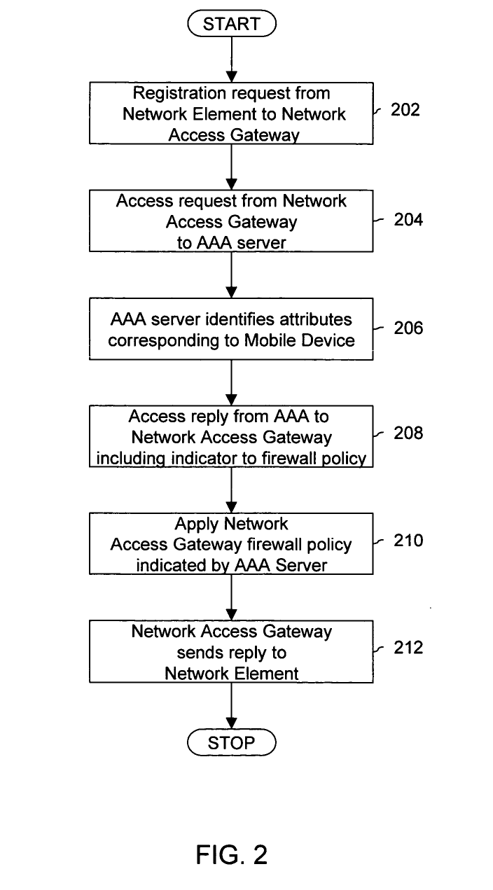

FIG. 2 illustrates in detail the exchange of information regarding the setting up of an appropriate firewall policy for Network Element 106. At step 202, Network Access Gateway 102 receives a registration request sent on behalf of Network Element 106. The registration request includes an identifier of Network Element 106. At step 204, Network Access Gateway 102 passes the information derived from this request to AAA Server 104 along with the identifier. At step 206, AAA Server 104 performs authentication, authorization and accounting services for Network Element 106. As a part of its functions, AAA Server 104 relates the identifier of Network Element 106 to the appropriate Network Access Gateway 102 and an appropriate firewall policy among the policies present in the firewall rulebase. Since the firewall rulebase is present on Network Access Gateway 102, AAA Server 104 only indicates the firewall policy appropriate for Network Element 106 by using a tag. The tag acts as an identification for choosing the firewall policy indicated by AAA Server 104 for Network Element 106. At step 208, the tag is communicated to Network Access Gateway 102 along with all the other attributes required for managing the network traffic. At step 210, Network Access Gateway 102 applies the firewall policy as indicated by the tag, to the network traffic of Network Element 106. Finally, at step 212, Network Access Gateway 102 sends the reply to Network Element 106 in response to its request for registration.

The mapping from identifier to tag can be direct. The identifier is typically an NAI (Network Access Identifier) or has the form user@domain.com. The AAA uses the NAI to determine the firewall policy based on an association preconfigured by the operator. This association can also be configured by domain. For example, all users of domain1.com could be associated with a particular policy tag while all users of domain2.com will be associated with a different policy tag.

According to an embodiment of the system of the present invention, firewall programs embedded on Network Access Gateway 102 support filtering of packets. It will evident to a person skilled in the art that Transport Control Protocol (TCP), User Datagram Protocol (UDP), Generic Routing Encapsulation (GRE), IPsec, or any other packet type may be supported by the system of the present invention.

In addition to providing TCP filtering capabilities, Network Access Gateway 102 of the present invention may keep track of all the open TCP connections from Network Element 106. For instance, Network Access Gateway 102 monitors the local IP address of Network Element 106, its local port, the IP address of the remote device with which Network Element 106 is exchanging packets of data, the remote port, etc.

Network Element 106 establishes a TCP session after receiving a response from Network Access Gateway 102. Once the TCP session is established, Network Access Gateway 102 allows incoming packets from the remote port and remote IP address to Network Element 106 on the appropriate local port. The appropriate local port for Network Element 106 is determined from the corresponding firewall policy on Network Access Gateway 102, which in turn was indicated by a tag sent by AAA Server 104. Network Access Gateway 102 allows packets from the remote port till the time a request for ending the session is received. The request for ending the session may be sent either by Network Element 106 or by the remote port, after which traffic from the remote host to the network element will be blocked. Network Access Gateway 102 closes the TCP session on receiving such a request. This imparts a dynamic nature to firewall capabilities present at Network Access Gateway 102.

It will be evident to a person skilled in the art that for Network Element 106, which may be a mobile device, a tunneling protocol may be used for transmission of data to Network Element 106. Some of the standards for tunneling that may be used are Mobile IP, L2TP, PPTP, IPsec, etc. Moreover, according to an embodiment of the present invention, firewall functions for mobile IP calls with reverse tunneling can be performed on the router of the home network of the mobile device. Thus, in case of a CDMA2000 network, firewall capabilities for a mobile device can be provided at the HA. Also, for all simple IP calls and mobile IP calls without reverse tunneling, firewall capabilities can be provided at the PDSN.

According to the present invention, for a given condition, filtering can be performed on a packet in exactly one location. Thus, for all Mobile IP calls with reverse tunneling, the filtering can be performed at the HA; for all simple IP calls the filtering can be performed on the PDSN; and for Mobile IP calls without reverse tunneling, the filtering can be performed at the PDSN and HA.

Additionally, firewall capabilities at AAA Server 104 can be configured to selectively restrict undesirable network probes or attacks. The PDSN and HA can be ‘hardened’ with firewall rules per interface. For example, the PDSN should only allow incoming user traffic on UDP port 699 (A11) and protocol type 47 (GRE) on the radio network interface. On the Internet interface, the PDSN should only allow incoming user traffic to or from UDP port 434, as well as protocol types 47 (GRE) and 4 (IP). The HA's Mobile IP interface should only accept user traffic on UDP port 434, as well as protocol types 47 (GRE) and 4 (IP). The PDSN and HA interfaces should be configured only to respond to pings only from a limited set of IP addresses and to allow remote logins (telnet and SSH) only from a limited set of IP addresses.

The AAA server of the present invention can be substituted with a local policy server. The local policy server is a server that is configured to indicate the policy corresponding to Network Element 106. When a local policy is in use, the PDSN or HA do not query the AAA server. Instead, the mapping of NAI to policy is done internally to the PDSN or HA. The PDSN looks up the mapping directly and then applies the appropriate policy.

In an alternative mode, both local policy and the AAA policy may be used, and typically the AAA policy will override any configured local policy.

The system, as described in the present invention or any of its components may be embodied in the form of a processing machine. Typical examples of a processing machine include a general purpose computer, a programmed microprocessor, a microcontroller, a peripheral integrated circuit element, and other devices or arrangements of devices, which are capable of implementing the steps that constitute the method of the present invention.

The processing machine executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the processing machine to perform specific tasks such as the steps that constitute the method of the present invention. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

It will to evident to one skilled in the art that it is not necessary that the various processing machines and/or storage elements be physically located in the same geographical location. The processing machines and/or storage elements may be located in geographically distinct locations and connected to each other to enable communication. Various communication technologies may be used to enable communication between the processing machines and/or storage elements. Such technologies include connection of the processing machines and/or storage elements, in the form of a network.

In the system and method of the present invention, a variety of “user interfaces” may be utilized to allow a user to interface with the processing machine or machines that are used to implement the present invention. The user interface is used by the processing machine to interact with a user in order to convey or receive information. The user interface could be any hardware, software, or a combination of hardware and software used by the processing machine that allows a user to interact with the processing machine. The user interface may be in the form of a dialogue screen and may include various associated devices to enable communication between a user and a processing machine. It is contemplated that the user interface might interact with another processing machine rather than a human user. Further, it is also contemplated that the user interface may interact partially with other processing machines while also interacting partially with the human user.

While the preferred embodiments of the invention have been illustrated and described, it will be clear that the invention is not limited to these embodiments only. Numerous modifications, changes, variations, substitutions, and equivalents will be apparent to those skilled in the art without departing from the spirit and scope of the invention as described in the claims.

What is claimed is:

1. A method for dynamic filtering of data packets at an access gateway in a network, the method comprising the steps of:
a. receiving a registration request on behalf of a network node for access to a network;
b. answering the registration request; and
c. filtering data packets associated with the network node.

2. The method according to claim 1 wherein the network is a home network.

3. The method according to claim 1 wherein the network is a foreign network.

4. The method according to claim 1 wherein the step of answering the registration request comprises granting access to the network.

5. The method according to claim 1 wherein the step of filtering data packets at the access gateway comprises performing the filtering at a packet data serving node of the foreign network.

6. The method according to claim 1 wherein the step of filtering data packets at the access gateway comprises performing the filtering at a home agent of the home network.

7. The method according to claim 1 wherein the step of filtering data packets comprises applying an appropriate security policy, the appropriate security policy being indicated by information inherent to the access gateway.

8. The method according to claim 7 wherein the step of applying appropriate security policy comprises:
a. selecting the appropriate policy, corresponding to the network node, from the set of policies maintained at the access gateway; and
b. applying the appropriate policy, the appropriate policy being maintained at the access gateway, to the communication of the network node.

9. The method according to claim 7 wherein the step of choosing the appropriate policy comprises choosing on the basis of domain name of the network node.

10. The method according to claim 7 wherein the step of selecting the appropriate policy from the set of policies maintained at the access gateway comprises a general security policy being configured, the general security policy being configured for all network nodes in the network.

11. The method according to claim 1 wherein the step of filtering data packets comprises applying an appropriate security policy, the appropriate security policy being indicated in a message received from an authentication, authorization and accounting server.

12. The method according to claim 11 wherein the step of filtering data packets comprises applying an appropriate security policy to the communication of the network node, the appropriate security policy being maintained at the access gateway.

13. A method for dynamic filtering of data packets at an access gateway in a foreign network, the method comprising the steps of:
a. receiving a registration request on behalf of a network node for access to a network, the registration request comprising an identifier wherein the identifier identifies the network node;
b. answering the registration request; and
c. filtering data packets associated with the network node at the access gateway.

14. The method according to claim 13 wherein the step of receiving a registration request comprises receiving a registration request for access to the network through mobile Internet Protocol.

15. The method according to claim 13 wherein the step of answering the registration request comprises granting access to the network.

16. The method according to claim 13 wherein the step of filtering data packets at the access gateway comprises performing the filtering at a packet data serving node of the foreign network.

17. The method according to claim 13 wherein the step of filtering data packets comprises applying an appropriate security policy, the appropriate security policy being indicated by information inherent to the access gateway.

18. The method according to claim 17 wherein the step of applying appropriate security policy comprises the steps of:
a. selecting the appropriate policy, corresponding to the network node, from the set of policies maintained at the access gateway; and
b. applying the appropriate policy, the appropriate policy being maintained at the access gateway, to the communication of the network node.

19. The method according to claim 17 wherein the step of choosing the appropriate policy comprises choosing on the basis of domain name of the network node.

20. The method according to claim 17 wherein the step of selecting the appropriate policy from the set of policies maintained at the access gateway comprises a general security policy being configured, the general security policy being configured for all network nodes in the network.

21. The method according to claim 13 wherein the step of filtering data packets comprises applying an appropriate security policy, the appropriate security policy being indicated in a message received from an authentication, authorization and accounting server.

22. The method according to claim 21 wherein the step of filtering data packets comprises applying an appropriate security policy to the communication of the network node the appropriate security policy being maintained at the access gateway,

23. A method for dynamic filtering of data packets at an access gateway in a home network, the method comprising the steps of:
a. receiving a registration request on behalf of a network node for access to a network, the registration request comprising an identifier wherein the identifier identifies the network node;
b. answering the registration request; and
c. filtering data packets associated with the network node at the access gateway.

24. The method according to claim 23 wherein the step of receiving a registration request on behalf of a network node comprises receiving the registration request from a mobile device.

25. The method according to claim 23 wherein the step of receiving a registration request comprises receiving a registration request for access to the network through mobile Internet Protocol.

26. The method according to claim 23 wherein the step of answering the registration request comprises granting access to the network.

27. The method according to claim 23 wherein the step of filtering data packets at the access gateway comprises performing the filtering at a home agent of the home network.

28. The method according to claim 23 wherein the step of filtering data packets comprises applying an appropriate security policy, the appropriate security policy being indicated by information inherent to the access gateway.

29. The method according to claim 28 wherein the step of applying appropriate security policy comprises the steps of:
a. selecting the appropriate policy, corresponding to the mobile device, from the set of policies maintained at the access gateway; and
b. applying the appropriate policy, the appropriate policy being maintained at the access gateway, to the communication of the mobile device.

30. The method according to claim 28 wherein the step of choosing the appropriate policy comprises choosing on the basis of domain name of the mobile device.

31. The method according to claim 28 wherein the step of selecting the appropriate policy from the set of policies maintained at the access gateway comprises a general security policy being configured, the general security policy being configured for all mobile devices in the network.

32. The method according to claim 23 wherein the step of filtering data packets comprises applying an appropriate security policy, the appropriate security policy being indicated in a message received from an authentication, authorization and accounting server.

33. The method according to claim 32 wherein the step of filtering data packets comprises applying an appropriate security policy to the communication of the network node, the appropriate security policy being maintained at the access gateway.

34. A system for dynamic filtering of data packets in a network, the system comprising:
a. at least one server for receiving a registration request made by a network node for access to the network resources, the server sending a reply to the network node in response to the registration request; and
b. an access gateway, embedded on the server, for performing filtering of data packets associated with the network node.

35. The system according to claim 34 wherein the server is a local policy server, the local policy server providing appropriate security policy for the network node to communicate with network resources.

36. The system according to claim 34 wherein the server in the network is a server providing authentication, authorization, and accounting services, the server indicating the appropriate security policy for the network node to communicate with network resources.

37. The system according to claim 34 wherein the access gateway is a packet data-serving node in a foreign network.

38. The system according to claim 34 wherein the access gateway is a home agent in a home network.

39. A system for dynamic filtering of data packets in a network, the system comprising:
a. at least one server for receiving registration request made by a network node for access to the network, the server sending a reply to the network node in response to the registration request; and
b. a packet data serving node in a foreign network, for performing filtering of data packets associated with the network node.

40. The system according to claim 39 wherein the server is a local policy server, the local policy server providing appropriate security policy for the network node to communicate with network resources.

41. The system according to claim 39 wherein the server in the network is a server providing authentication, authorization, and accounting services, the server indicating the appropriate security policy for the network node to communicate with network resources.

42. A system for dynamic filtering of data packets in a network, the system comprising:
a. at least one server for receiving registration request made by a network node for access to the network, the server sending a reply to the network node in response to the registration request; and
b. a home agent in a home network, for performing filtering of data packets associated with the network node.

43. The system according to claim 42 wherein the server is a local policy server, the local policy server providing appropriate security policy for the network node to communicate with network resources.

44. The system according to claim 42 wherein the server in the network is a server providing authentication, authorization, and accounting services, the server indicating the appropriate security policy for the network node to communicate with network resources.

45. A computer program product for use with a computer, for dynamic filtering of data packets at an access gateway in a communication network, the computer program product performing the steps of:
a. receiving a registration request on behalf of a network node for access to the network, the registration request comprising an identifier wherein the identifier identifies the location of the network node;
b. answering the registration request; and
c. filtering data packets associated with the network node, wherein the location of filtering being decided on the basis of the identifier.
